(19) United States
(12) Patent Application Publication
(10) Pub. No.: US 2019/0340012 A1
(43) Pub. Date: Nov. 7, 2019

(54) SYSTEM FOR EFFICIENT RESOURCE DISTRIBUTION

(71) Applicant: Ruthann Granito, Charlotte, NC (US)

(72) Inventor: Ruthann Granito, Charlotte, NC (US)

(21) Appl. No.: 16/401,901

(22) Filed: May 2, 2019

Related U.S. Application Data
(60) Provisional application No. 62/666,749, filed on May 4, 2018.

(51) Int. Cl. G06F 9/46; G06F 9/50; G06Q 40/08; G06F 9/54

(52) U.S. Cl. CPC G06F 9/466; G06F 9/5011; G06F 9/542; G06Q 40/08; G06F 9/5061

(57) ABSTRACT

A system for efficient resource distribution may be configured to detect a transaction of a first resource between a first third party and a user; determine an optimal allocation scheme for the first resource, wherein the optimal allocation scheme comprises resource performance criteria provided by the first third party and data associated with the user; determine, based on the optimal allocation scheme, an optimal second resource to be acquired by the first third party; create a first partitioned resource and a second partitioned resource from the first resource; exchange the second partitioned resource for the second resource; and send an alert to the first third party of a resource exchange condition based on the resource performance criteria.

### PRIORITY CLAIM

This application claims priority to U.S. Provisional Application Ser. No. 62/666,749, entitled SYSTEM FOR EFFICIENT RESOURCE DISTRIBUTION, filed May 4, 2018, which is incorporated herein by reference in its entirety.

### FIELD OF THE INVENTION

The present invention embraces a system for efficient distribution of third-party resources.

### BACKGROUND

Computer systems are often used to facilitate distribution or exchange of resources between multiple parties. That said, there is a need for a system for managing resources in a more efficient manner.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide a resource distribution system comprising a processor; a communication interface; and a memory having a resource distribution server application stored within. The resource distribution server application, when executed by the processor, causes the processor to detect a transaction of a first resource between a first third party and a user; determine an optimal allocation scheme for the first resource, wherein the optimal allocation scheme comprises resource performance criteria provided by the first third party and data associated with the user; determine, based on the optimal allocation scheme, an optimal second resource to be acquired by the first third party; create a first partitioned resource and a second partitioned resource from the first resource; exchange the second partitioned resource for the second resource; and send an alert to the first third party of a resource exchange condition based on the resource performance criteria, wherein the alert comprises a notification or recommendation to exchange a securitized or non-securitized resource for a third resource.

In some embodiments, the resource distribution server application further causes the processor to receive an acknowledgement of the notification or recommendation from the first third party; generate the securitized or non-securitized resource according to the allocation scheme; and execute an exchange of the securitized or non-securitized resource for the third resource between the first third party and the second third party.

In some embodiments, the memory further comprises an online portal to facilitate the transaction of the first resource between the first third party and the user.

In some embodiments, the transaction of the first resource is loan funding, the second resource is a life insurance policy, the output of the second resource is the benefit of the life insurance policy, the securitized or non-securitized resource comprises at least an output of the second resource, the third resource is purchase funds, the first third party is a lender, the second third party is an investor, and the user is a borrower.

In some embodiments, the resource distribution server application further causes the processor to constantly monitor the status of the user to detect a condition that causes the second resource to mature.

In some embodiments, the resource distribution server application further causes the processor to generate a set of projected values for the securitized or non-securitized resource and store the set of projected values within a database in the memory.

In some embodiments, the set of projected values are generated based on resource parameters, a set of objectives of the first third party and the user's biographical data.

In some embodiments, the securitized or non-securitized resource is a securitized resource.

In some embodiments, the securitized or non-securitized resource is a non-securitized resource.

Embodiments of the present invention further provide a computer program product for distribution of third-party resources. The computer program product may comprise at least one non-transitory computer readable medium having computer-readable program code portions embodied therein. The computer-readable program code portions may comprise executable code portions for detecting a transaction of a first resource between a first third party and a user; determining an optimal allocation scheme for the first resource, wherein the optimal allocation scheme comprises resource performance criteria provided by the first third party and data associated with the user; determining, based on the optimal allocation scheme, an optimal second resource to be acquired by the first third party; creating a first partitioned resource and a second partitioned resource from the first resource; exchanging the second partitioned resource for the second resource; and sending an alert to the first third party of a resource exchange condition based on the resource performance criteria, wherein the alert comprises a notification or recommendation to exchange a securitized or non-securitized resource for a third resource.

In some embodiments, the computer-readable program code portions further comprise executable code portions for receiving an acknowledgement of the notification or recommendation from the first third party; generating the securitized or non-securitized resource according to the allocation scheme; and executing an exchange of the securitized or non-securitized resource for the third resource between the first third party and the second third party.

In some embodiments, the computer-readable program code portions further comprise executable code portions for generating a set of projected values for the securitized or non-securitized resource; and storing the set of projected values within a database in a memory.

In some embodiments, the set of projected values are generated based on resource parameters, a set of objectives of the first third party and the user's biographical data.

In some embodiments, the securitized or non-securitized resource is a securitized resource.

In some embodiments, the securitized or non-securitized resource is a non-securitized resource.

Embodiments of the present invention further provide a computer-implemented method for distribution of third-party resources. The method may comprise detecting a transaction of a first resource between a first third party and a user; determining an optimal allocation scheme for the first resource, wherein the optimal allocation scheme comprises resource performance criteria provided by the first third party and data associated with the user; determining, based on the optimal allocation scheme, an optimal second resource to be acquired by the first third party; creating a first partitioned resource and a second partitioned resource from the first resource; exchanging the second partitioned resource for the second resource; and sending an alert to the first third party of a resource exchange condition based on the resource performance criteria, wherein the alert comprises a notification or recommendation to exchange a securitized or non-securitized resource for a third resource.

In some embodiments, the method further comprises receiving an acknowledgement of the notification or recommendation from the first third party; generating the securitized or non-securitized resource according to the allocation scheme; and executing an exchange of the securitized or non-securitized resource for the third resource between the first third party and the second third party.

In some embodiments, the method further comprises generating a set of projected values for the securitized or non-securitized resource; and storing the set of projected values within a database in a memory.

In some embodiments, the set of projected values are generated based on resource parameters, a set of objectives of the first third party and the user's biographical data.

In some embodiments, the securitized or non-securitized resource is a securitized resource.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts an operating environment, in accordance with one embodiment of the present invention;

FIG. 2 depicts a schematic of an entity resource distribution server and a third party transferor server, in accordance with one embodiment of the present invention; and

FIG. 3 depicts a process flow for facilitating an exchange of resources, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“User” as used herein may be an individual who wishes to interact with a third party. In such embodiments, the system serves as the interface between the user and the third party to facilitate transactions between them. In some embodiments, the user may refer to an individual or entity that is authorized and authenticated to utilize or participate in a system involving non-securitized resources, or for securitizing resources as described herein. In some embodiments, the user may be an individual associated with an entity that owns and/or operates the securitization system.

“User device” as used herein may refer to a computing device used by the user to access the system through a third party server. The user device may include a processor, a non-transitory storage medium, a communications device, and a display. The system may support user logins and inputs from any combination of similar or disparate devices. Accordingly, the user device may be a portable electronic device such as a smartphone, tablet, or laptop. In other embodiments, the user device may be a stationary unit such as a personal desktop computer or a networked terminal within a third party's premises.

“Third party” as used herein may refer to an individual or organization for whom or for which resources are matched, exchanged, managed, or securitized. Typically, one or more users will use the system to manage resources based on the third party's particular requirements.

“Entity” as used herein may refer to an individual or an organization that owns and/or operates the computing systems on which the securitization system is implemented. The entity may be a business organization, a non-profit organization, a government organization, and the like. Typically, the entity owns a networked computing system or multiple networked computing systems, which may include computer terminals configured to be operated by one or more users and servers which may execute a number of functions without direct user input.

“Resource” as used herein may refer generally to an asset that may be used or exchanged between parties, such as information, funds or investments. In some embodiments, the resource is an asset that is managed and/or securitized by the user for the benefit of the third party. In some embodiments, a resource may be benefits managed on behalf of a third party, such as proceeds from an insurance policy.

Embodiments of the present invention provide a system, computer program product, and method for efficient collateralization of resources and their subsequent securitization. In particular, the system may manage the allocation or partition of resources on behalf of a third party. The system may further coordinate the securitization of non-publically traded resources on behalf of a first third party and transfer the privately securitized resource to a second third party. For instance, the system may be owned and/or operated by an entity that provides advising, matching or financial services to government agencies, institutions and investors. In an exemplary embodiment, the system may modify the manner in which a government agency or private institution (e.g., the first third party) allocates loan funding to its borrowers. In particular, the system may facilitate the transaction between a user (e.g., a student who wishes to take out an educational loan) and the lending institution by allocating one portion of the loan funding to be disbursed to the borrower while utilizing the remaining portion of the loan to purchase collateral for the loan by funding the purchase of a life insurance policy on the user on behalf of the first third party, where the policy names the borrower as the insured and the first third party as the beneficiary and policy owner. The system may then market the sale of individual or bundled collateral to the loans, either securitized or not, locate potential purchasers or investors (e.g., the second third party) to purchase the collateral and provide a platform for the market exchange of the collateral in the private sector.

To illustrate, the lender may allocate a total of $50,000 for the loan to the student. The educational institution receives $30,000 of the total to be spent on educational expenses. The remaining $20,000 is used by the system to, on behalf of the lender, purchase a life insurance policy tailored to the objectives of the lender, on the student, which could have a benefit of a guaranteed repayment to the lender of a large multiple of the loan upon maturation. The lender is the controlling party, being named as both the owner (having an insurable interest) and the beneficiary of the policy. The insurance policy is employed to guarantee payment of the loan, and so the accounts receivable of the loan typically includes the benefit of the insurance policy which more than offsets the payment of the debt. Typically, an average duration of the policy until maturation will be 60 years (assuming an average student age of 20 and an average age at death of 80). The lender will have the option of holding the policy until maturation, which in this example will have an implied interest rate calculated based on the product used, or selling the benefit of the policy (e.g., either by transferring the ownership of the policy, or by selling the accounts receivable of the loan) to an investor at a point in time before maturation of the policy, which may lead to a higher implied interest rate, or a lower rate but with an imbedded faster repayment. The system typically provides the lender with recommendations (as well as alternative options) regarding the most favorable choice of insurance policy and whether/when to hold or sell to the lender based on its calculations and financial goals (e.g., desired rate of return, cash needs, and the like) of the lender. It should be noted that the system is configured to ensure, at a minimum, that the lender will receive a return that is equal to or greater than the initial repayment principal, which in this example would be the amount lent (i.e., $50,000), as well as any corresponding interest on the loan. In such an instance, the loan is guaranteed by the return from the life insurance policy, and the student is deemed to have repaid the loan. In this way, the system provides an efficient way to allow third parties to lend money, be assured at some time in the future of repayment, securitize their resources and enter into transactions with users and other third parties. The entity that owns and operates the system may receive fees from the various third parties for the service in a number of different ways, such as subscription fees, evaluation fees, loan origination fees, commissions, and the like.

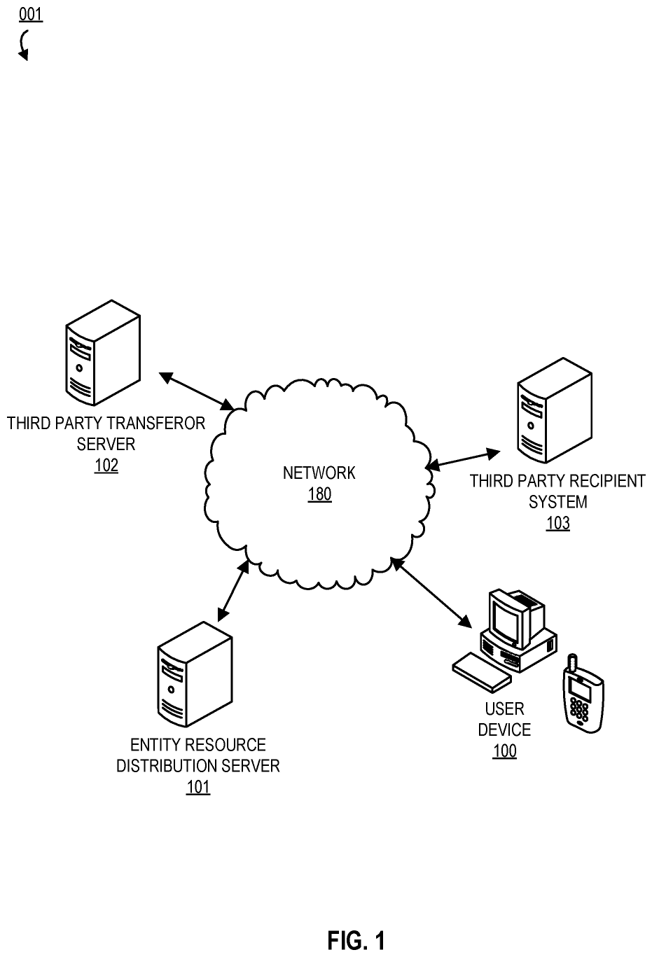

FIG. 1 is a block diagram illustrating an operating environment 001, in accordance with one embodiment of the present invention. The operating environment may include an entity resource distribution server 101 in operative communication with a user device 100, a third party transferor server 102, and a third party recipient server 103 over a network 180. The network 180 may also be a global area network (GAN), such as the Internet, a wide area network (WAN), a local area network (LAN), or any other type of network or combination of networks. The network 180 may provide for wireline, wireless, or a combination wireline and wireless communication between devices on the network 180. Typically, the entity resource distribution server 101 is responsible for running the resource distribution application and running its various processes. Through the resource distribution application, the entity resource distribution server 101 coordinates resource transfers between the user device 100 and the third party transferor server 102, such as loan agreements. The entity resource distribution server 101 further coordinates with the third party recipient system 103 when initiating transfers of the collateral in the form of securitized or non-securitized resources. The third party recipient system 103 may be a personal computing device used by a potential investor, or alternatively may be a server owned by a financial institution through which investors may agree to purchase the collateral. It should be understood that the resource distribution server 101 as depicted herein may be embodied in a single server or multiple servers distributed over varying geographic distances.

In a typical embodiment, the user device 100 associated with a user is used to interact with the third party transferor server 102 associated with a first third party to create an agreement between the user and the first third party. In some embodiments, the agreement may be a contract to obtain a student loan. In some embodiments, the entity resource distribution server 101 serves as a portal through which the user device 100 may connect to the third party transferor server 102. In some embodiments the entity resource distribution server 101 may connect to entities offering products which provide the collateral being sought by the first third party, and may additionally provide a filtering system to determine the best matched product to the first third party's objectives. In other embodiments, the third party transferor server 102 maintains the portal allowing a direct connection to the user device 100, in which case the entity resource distribution server 101 accesses the records stored on the third party transferor server 102 to run its various processes. The entity resource distribution server 101 may access said records at designated intervals, near real-time, or on demand as dictated by the third party transferor server.

The entity resource distribution server 101 may require that authentication credentials are provided by the user device 100. In some embodiments, the authentication credentials may include proof of licensing, a username, password, a biometric identifier, a cryptographic key, a token, and the like. The entity resource distribution server 101 may further require that more than one authentication credential is provided as parts of a multi-step authentication process.

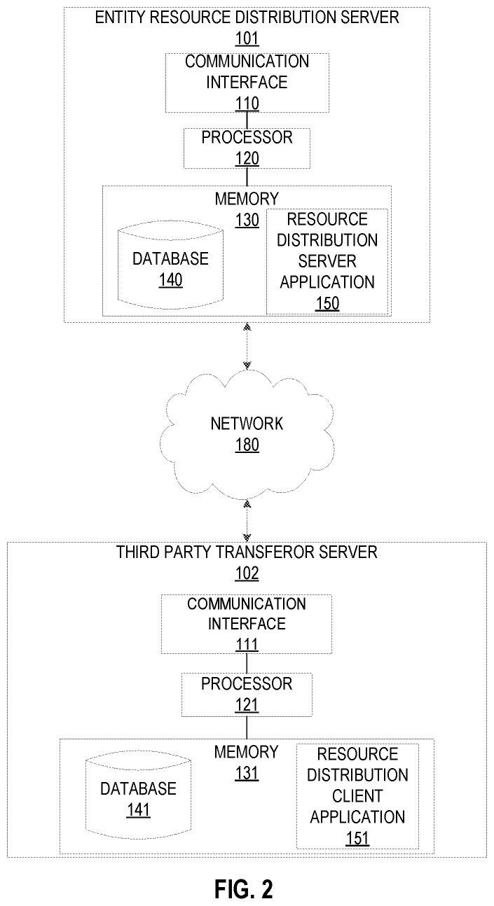

FIG. 2 is a block diagram illustrating the entity resource distribution server 101 and the third party transferor server 102 in more detail, in accordance with one embodiment of the present invention. The entity resource distribution server 101 typically contains a processor 120 communicably coupled to such devices as a communication interface 110 and a memory 130. The processor 120, and other processors described herein, typically includes circuitry for implementing communication and/or logic functions of the server 101. For example, the processor 120 may include a digital signal processor device, a microprocessor device, and various analog to digital converters, digital to analog converters, and/or other support circuits.

The entity resource distribution server 101 may use the communication interface 110 to communicate with other devices over the network 180. The communication interface as used herein may include an Ethernet interface, an antenna coupled to a transceiver configured to operate on a cellular data or WiFi signal, and/or a near field communication (“NFC”) interface.

The entity resource distribution server 101 may include a memory 130 operatively coupled to the processor 120. As used herein, memory includes any computer readable medium (as defined herein below) configured to store data, code, or other information. The memory may include volatile memory, such as volatile Random Access Memory (RAM) including a cache area for the temporary storage of data, or such as a cache for the storage of data in a write once read many format (WORMS). The memory may also include non-volatile memory, which can be embedded and/or may be removable. The non-volatile memory can additionally or alternatively include an electrically erasable programmable read-only memory (EEPROM), flash memory or the like.

Typically, a resource distribution server application 150 is stored within the memory 130 to implement the functions of the securitization system through the processor 120 on the entity resource distribution server 101. The resource distribution server application 150 communicates with the third party transferor server 102 in order to carry out the functions of managing and securitizing resources. In particular, the resource distribution server application 150 includes the logic code portions to determine the appropriate amount of a resource to be bundled, securitized or left in a non-securitized format, as well as an estimated valuation of each portion of the collateral (resource) at a given point in time. The resource distribution server application 150 may further dynamically calculate projections of valuations of the securitized or non-securitized resource at particular time points.

The memory 130 may further include a database 140 containing data to be processed and/or manipulated by the resource distribution server application 150. The database 140 may contain historical data records as well as projections for each resource for each third party. It should be understood that while the database 140 is depicted as a single unit within a single resource distribution server, the database 140 may represent multiple databases implemented across multiple resource distribution servers 101. It should also be understood that the resource distribution server application 150 may be implemented in a distributed manner amongst a plurality resource distribution servers 101. The database 140 may also be stored on a separate, distinct memory 130 from the resource distribution server application 150.

The third party transferor server 102 typically also includes a processor 121 operatively coupled to a communication interface 111 and a memory 131. The memory 131 typically stores a resource distribution client application 151, which is configured to communicate with the resource distribution server application 150 within the entity resource distribution server 101. In some embodiments, the resource distribution client application 151 may be specific software provided by the entity associated with the entity resource distribution server 101. In other embodiments, the client application may be a general software application, such as a web browser, configured to communicate with servers over standard communications protocol such as HTTP, FTP, POP, IMAP, and the like. The resource distribution client application 151 establishes a connection with the resource distribution server application 150 over the network 180 to allow for the transfer of data relating to the third party's resources.

The memory 131 of the third party transferor server 102 may further comprise a database 141 in which historical data regarding the third party's resources is stored. In some embodiments, the historical data comprises information regarding allocation of the third party's funds when entering into loan transactions with a user. The information may further include biographical information about the user, such as the age, gender, occupation, known medical information, and other relevant risk factors. The system may further track the death of the user and store historical data about the payout of the insurance policy within the database. Alternatively, the biographical information may be stored in the database 140 within the entity resource distribution server 101. The information may further include historical information and factors about the first third party which may be relevant to providing them with advice or notices or to matching first third parties with second third parties. It should be understood that the third party transferor server 102 as depicted in FIG. 2 may additionally or alternatively represent the third party recipient system 103 and/or the user device 100, or any other device which may host an application (e.g., the resource distribution client application 151) for accessing the resource distribution server application 150 hosted on the entity resource distribution server 101.

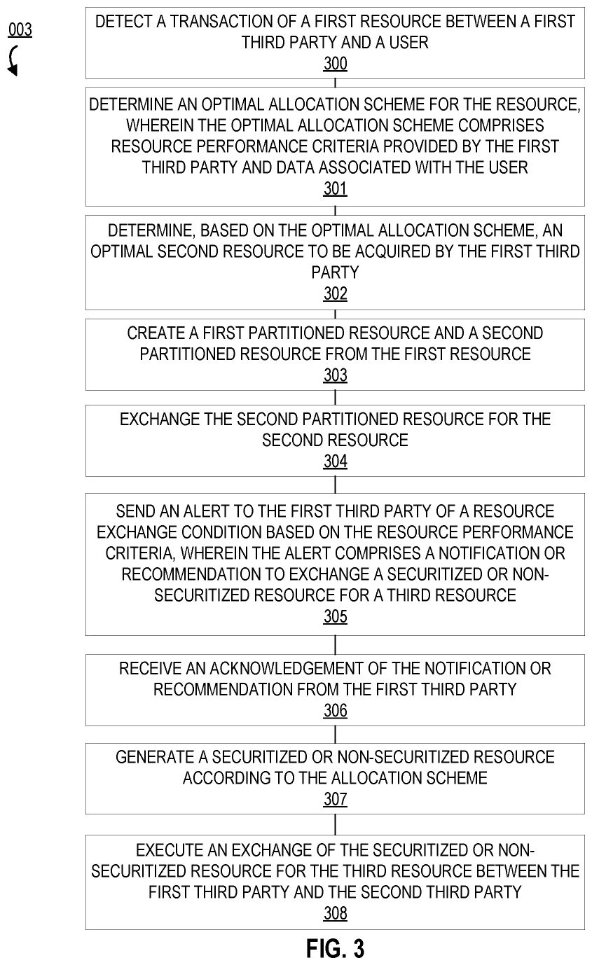

FIG. 3 illustrates a process flow 003 for facilitating an exchange of a partitioned resource, in accordance with one embodiment of the present invention. The process begins at block 300, where the system detects a transaction of a first resource between a first third party and a user. In one embodiment, the system is owned by an entity and may detect through the third party transferor server associated with the first third party that the first third party has entered into an agreement to provide loan funding (e.g., the first resource) to a user. The first third party may be a lender such as a financial or educational institution, trust, corporation, governmental entity, or any other organization or person that lends money. The entity may be a financial institution, trust, corporation, or other organization that manages the collateralization of loans for the lender and further, the repackaging of the collateral for private or public sale, exchange or trading. Typically, the lender (e.g., the first third party) is a financial or educational institution or governmental entity that provides student loans. Accordingly, the user is typically a student seeking loan funding from the lender. In some embodiments, the system is used to coordinate the actualization of a further sale, exchange or trading of the collateral of a loan that is already in existence between the student and the lender. In such an embodiment, the system may periodically query the database within the third party transferor server to obtain updated information about transactions entered into by the first third party. Alternatively, the third party transferor server may be configured to send updated transaction data to the entity resource distribution server whenever the first third party enters into a new transaction with a user or the terms of an existing transaction has changed. In yet another embodiment, the student may log onto the entity's system to upload a loan commitment letter received from the lender in order to have the system entity complete the disbursement process.

In some embodiments, the entity may be involved in the initial process of coordinating a loan agreement between the student and the lender. In such an embodiment, the entity resource distribution server may serve as the intermediary to facilitate communication between the first third party and the user and further, to act as the data processing center such that the system entity may provide notification and advising functions as well as making available to the first third party a product that may be chosen as collateral for the loan according to the data previously provided by the first third party to the system entity. In this regard, the student may log into the entity's servers to begin the loan agreement process. The entity resource distribution server may then automatically generate the necessary documents to conduct the allocation of funds, selection of the collateral and later re-packaging, sale, bundling, or securitization of the collateral to the loan.

The process continues to block 301, where the system determines an optimal allocation scheme for the first resource, wherein the optimal allocation scheme comprises resource performance criteria provided by the first third party and data on the user. The optimal allocation scheme may specify how to partition the first resource and how to allocate the partitions once they have been created. The optimal allocation scheme may include resource performance criteria provided by the lender. The performance criteria are specific to the particular lender's needs, and may include criteria such as rates of return, time until liquidation, hedging and management of risk, diversification, and the like. In one embodiment, the lender may choose to focus on achieving the highest rates of return as possible. In another embodiment, the lender may decide that a diverse portfolio of collateral takes priority over simply maximizing return rates, in order to better fulfill their needs, etc. The lender may further have a desired timeframe or deadline by which he desires to monetize the collateral asset. The system may then choose whether to alert the lender with a recommended action (e.g., a recommendation to sell the collateral asset to an investor for a certain amount) based on the lender's preferred standards of performance.

In a typical embodiment, the system determines that one portion of the loan funding will be used to pay for the student's tuition. In some embodiments, this portion may be disbursed directly to the student. In other embodiments, this portion may be disbursed directly to the educational institution. In some embodiments, multi-year funding may have been obtained and the system will manage disbursement over time. The remaining portion of the loan funding will typically be used to purchase a life insurance policy which names the student as the insured and the lender as the owner and beneficiary. In some embodiments, the insurance policy may be a whole life policy, a single payment premium universal policy, a policy obtained through the system's research in the existing marketplace, or it may be a life insurance product proprietary to the entity. This life insurance policy is typically used to guarantee that the first third party (e.g., the lender) is repaid the full amount of the loan, as well as interest due on the loan. Accordingly, the system typically determines the type and features (e.g., benefit amount, rate of return, insurance carrier, and the like) of the life insurance policy based on a number of risk and financial factors, such as the student's age, biographical information, medical information, amount of the loan, interest rate of the loan, expected rate of return of the policy, expected duration of the policy, the payout upon maturation, and the ability of an insurance carrier that provides the policy to pay upon policy maturation, which may be reflected in a rating of the insurance carrier. The optimum amount of the life insurance policy may also depend on the loan amount and the objectives of the first third party. The student's risk of default is not taken into account because the student has satisfied the obligation for repayment by allowing the system to, on behalf of the lender, take out a life insurance policy on the student, thereby covering the full amount loaned. (e.g., the benefit of life insurance policy itself serves as the “repayment”). In such an embodiment, the key risk is the claims paying ability of the insurance carrier, rather than the risk of default by the student. The system may further calculate projections of the worth of the policy based on various parameters associated with the policy, such as the duration of the policy until maturity, ability of the first third party lender to borrow against the collateral, ability of the holder of the collateral to surrender it for immediate monetization, expected rate of return, and the like. Based on this information and in order to guarantee repayment of the loan, the system will typically select a life insurance policy such that the present value of such policy meets or exceeds the present value of the loan. In some embodiments, the system may select multiple life insurance policies from one or more insurance carriers that, in combination, have an acceptable present value. In some embodiments, the system may provide the lender with multiple life insurance policy options based upon the performance criteria provided by the lender, after which the lender may select the life insurance policy (or collection of policies) that best meet such performance criteria. Such life insurance policy options may include a recommendation of a particular life insurance policy that the system determined to best meet the performance criteria (i.e. “the best interest of the first third party”).

In some embodiments, the system may further comprise a software advisor to optimize use of the system according to the performance criteria set by the lender. In this way, the system is able to make recommendations to match the lender's desires and expectations of performance and to be in the lender's best interest. The advisor may be configured to monitor the performance of all of the lender's collateral assets (e.g., receivable for groups of loans) by examining market conditions, insurance carrier declaration of dividends and trends, and the like. Typically, this may be accomplished by comparing the implied interest rate of the receivables against benchmark data stored within the system's database. The benchmark data may be based on historical data from the performance of receivables collected by the system over time. The system may then detect that a favorable action may be taken by the lender to increase the performance of a receivable, usually by detecting that the implied interest rate from the favorable action will be higher than the implied interest rate of the current action. The system may send a notification to the lender to notify them on the ability to actualize the favorable action. For example, the lender may currently be retaining an accounts receivable for a particular insurance policy with a certain implied interest rate. The system, upon analyzing market conditions, may detect that the lender may have an opportunity to realize a higher rate of return or fulfillment of the current objective if the lender chooses to sell the collateral asset instead of keeping it.

The process continues to block 302, where the system determines, based on the optimal allocation scheme, an optimal second resource to be acquired by the first third party. In some embodiments, the second resource is an insurance policy. In such an embodiment, the optimal insurance policy is selected based on the lender's needs and performance criteria as described above. Selecting an insurance carrier may further be based on characteristics of the insurance carrier itself such as its solvency, ability to pay, rating, product features and the like. In some embodiments, the system may generate a proprietary ratings system for a number of insurance carriers. The ratings system may be based on historical data collected by the system from past transactions with the insurance carriers as applied to first third party criteria. Policy features along with claims paying ability may affect the rating given. In this way, the system may be more likely to select carriers with a higher rating for future insurance policy purchases.

The process continues to block 303, where the system creates a first partitioned resource and a second partitioned resource according to the allocation scheme. Typically, the first partitioned resource is the portion of the allocated loan funds to be used for tuition, and the second partitioned resource is the portion of the allocated loan funds that is used to purchase the life insurance policy. At this step, the system disburses the first partitioned resource (e.g., loan funds to be used for tuition) to the student, either directly or on the student's behalf to an educational institution.

The process continues to block 304, where the system exchanges the second partitioned resource for the second resource, the specific identification of which was determined at the time of confirmation of the loan after system analysis of the data. Typically, the second resource is the determined insurance policy, and the second partitioned resource is the portion of loan funds allocated for purchasing the life insurance policy. In other words, based on the optimal allocation scheme and resource performance criteria as described above, the system may then automatically purchase the determined life insurance policy. In some embodiments, the lender may elect to maintain ownership of the collateral asset (e.g., the life insurance policy) the policy matures. To this end, the system may continually monitor the status of the user to detect a condition for an insurance payout. Once said condition is satisfied, the system may facilitate the transfer of payout funds to the lender. In some embodiments, the lender may elect to sell the insurance policy before the maturation of the policy (e.g., by selling the insurance policy or benefits under it). In other embodiments, the policy may be repackaged and annuitized and held past the maturation date, all depending on the lender's performance criteria and the collateral held.

The process continues to block 305, where the system sends an alert to the first third party of a resource exchange condition based on the resource performance criteria, wherein the alert comprises a notification or recommendation to exchange an output of the second resource for a third resource. Typically, the output of the second resource is the policy receivable for the collateral on the loan, which as noted typically includes the benefit of the life insurance policy, and the third resource is an amount of purchase funds to be given in exchange for the receivable. The resource exchange condition is typically a favorable opportunity to meet or exceed the performance criteria set by the lender, such as an opportunity for immediate monetization of the collateral. For instance, the system may detect an opportunity to realize a higher rate of return, to mitigate risk, to obtain a return on an earlier timeframe, and the like. Once such an opportunity has been detected, the system may send an alert to a computing device owned by the lender with a notification of the event or recommendation to sell the asset. In some embodiments, the system may recommend bundling certain assets from different first third parties together to optimize performance on the private market. For instance, bundling the assets which may hold the same of divergent terms or features may make the availability for purchase more attractive to potential investors, which may increase the rate of return to first third parties.

The process continues to block 306, where the system receives an acknowledgement of the notification or recommendation from the first third party. In one embodiment, the lender has manifested a wish to monetize the collateral asset and has agreed to sell the receivable(s) at this stage. The system may then generate an offer to the private market for the sale of the asset, and when a purchaser is apparent, the necessary documents for facilitating the transfer of the receivables for the purchase funds.

The process continues to block 307, where the system generates a securitized or non-securitized resource according to the allocation scheme. Typically, the system generates the resource to effectuate the first third party's sale or exchange with the second third party. At this step, the system may then either create a special purpose vehicle or elect to utilize an existing special purpose vehicle, which may be an organization such as a partnership, trust, corporation, or other such organizations, which is typically separate from the lender and the entity. The special purpose vehicle may serve as the organization which maintains a portfolio of accounts receivables from loans (and associated life insurance policies) made by the lender (e.g., to different students). The system then transfers the accounts receivable of the loan to the special purpose vehicle. Securitization of the loan typically includes combining receivables for the loan (e.g., future payouts on the life insurance policy) with receivables for loans made to other students. The combined receivables may then be sold to investors. Separate portions of the combined receivables may be sold at different times and/or held until maturity based on the performance criteria of the lender. In certain situations, receivables may be bundled and receive different ratings from the entity or system, and may be packaged to be subordinate to other bundled receivables. The system may determine a listing price based on present value of the accounts receivable based on numerous risk factors as described above, as well as based on investor demand. Typically, the combined receivables are sold to investors on the private market. In some embodiments, the entity resource distribution server may comprise a database and web portal through which potential buyers may browse the various securitized resources on offer. In some embodiments, the entity resource distribution server may communicate with and utilize its own or a private selling facility for listing the securitized resource for sale. In yet other embodiments, the system may contact the entity or investor directly to initiate the transaction.

The process concludes at block 308, where the system executes the exchange of the securitized or non-securitized resource for the third resource between the first third party and the second third party. Upon receiving a confirmation from a buyer (e.g., the second third party), the system automatically generates the documentation, at times utilizing its data network with the policy carrier, necessary to allow the lender (e.g., the first third party) to transfer ownership of the securitized resource (e.g., via the special purpose vehicle) to the buyer at an agreed upon price.

Each communication interface described herein generally includes hardware and software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams, may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A resource distribution system comprising:
a processor;
a communication interface; and
a memory having a resource distribution server application stored within, wherein the resource distribution server application, when executed by the processor, causes the processor to:
detect a transaction of a first resource between a first third party and a user;
determine an optimal allocation scheme for the first resource, wherein the optimal allocation scheme comprises resource performance criteria provided by the first third party and data associated with the user;
determine, based on the optimal allocation scheme, an optimal second resource to be acquired by the first third party;
create a first partitioned resource and a second partitioned resource from the first resource;
exchange the second partitioned resource for the second resource; and
send an alert to the first third party of a resource exchange condition based on the resource performance criteria, wherein the alert comprises a notification or recommendation to exchange a securitized or non-securitized resource for a third resource.

2. The resource distribution system according to claim 1, wherein the resource distribution server application further causes the processor to:
receive an acknowledgement of the notification or recommendation from the first third party;
generate the securitized or non-securitized resource according to the allocation scheme; and
execute an exchange of the securitized or non-securitized resource for the third resource between the first third party and a second third party.

3. The resource distribution system of claim 2, wherein the memory further comprises an online portal to facilitate the transaction of the first resource between the first third party and the user.

4. The resource distribution system of claim 2, wherein the transaction of the first resource is loan funding, the second resource is a life insurance policy, the output of the second resource is a benefit of the life insurance policy, the securitized or non-securitized resource comprises at least an output of the second resource, the third resource is purchase funds, the first third party is a lender, the second third party is an investor, and the user is a borrower.

5. The resource distribution system of claim 4, wherein the resource distribution server application further causes the processor to constantly monitor a status of the user to detect a condition that causes the second resource to mature.

6. The resource distribution system of claim 2, wherein the resource distribution server application further causes the processor to:
generate a set of projected values for the securitized or non-securitized resource; and
store the set of projected values within a database in the memory.

7. The resource distribution system of claim 6, wherein the set of projected values are generated based on resource parameters, a set of objectives of the first third party and biographical data of the user.

8. The resource distribution system of claim 1, wherein the securitized or non-securitized resource is a securitized resource.

9. The resource distribution system of claim 1, wherein the securitized or non-securitized resource is a non-securitized resource.

10. A computer program product for distribution of third-party resources, the computer program product comprising at least one non-transitory computer readable medium having computer-readable program code portions embodied therein, the computer-readable program code portions comprising executable code portions for:
detecting a transaction of a first resource between a first third party and a user;
determining an optimal allocation scheme for the first resource, wherein the optimal allocation scheme comprises resource performance criteria provided by the first third party and data associated with the user;
determining, based on the optimal allocation scheme, an optimal second resource to be acquired by the first third party;
creating a first partitioned resource and a second partitioned resource from the first resource;
exchanging the second partitioned resource for the second resource; and
sending an alert to the first third party of a resource exchange condition based on the resource performance criteria, wherein the alert comprises a notification or recommendation to exchange a securitized or non-securitized resource for a third resource.

11. The computer program product of claim 10, wherein the computer-readable program code portions further comprise executable code portions for:
receiving an acknowledgement of the notification or recommendation from the first third party;
generating the securitized or non-securitized resource according to the allocation scheme; and
executing an exchange of the securitized or non-securitized resource for the third resource between the first third party and a second third party.

12. The computer program product of claim 11, wherein the computer-readable program code portions further comprise executable code portions for:
generating a set of projected values for the securitized or non-securitized resource; and
storing the set of projected values within a database in a memory.

13. The computer program product of claim 12, wherein the set of projected values are generated based on resource parameters, a set of objectives of the first third party and biographical data of the user.

14. The computer program product of claim 10, wherein the securitized or non-securitized resource is a securitized resource.

15. The computer program product of claim 10, wherein the securitized or non-securitized resource is a non-securitized resource.

16. A computer-implemented method for distribution of third-party resources, the method comprising:
detecting a transaction of a first resource between a first third party and a user;
determining an optimal allocation scheme for the first resource, wherein the optimal allocation scheme comprises resource performance criteria provided by the first third party and data associated with the user;
determining, based on the optimal allocation scheme, an optimal second resource to be acquired by the first third party;
creating a first partitioned resource and a second partitioned resource from the first resource;
exchanging the second partitioned resource for the second resource; and
sending an alert to the first third party of a resource exchange condition based on the resource performance criteria, wherein the alert comprises a notification or recommendation to exchange a securitized or non-securitized resource for a third resource.

17. The computer-implemented method of claim 16, the method further comprising:
receiving an acknowledgement of the notification or recommendation from the first third party;
generating the securitized or non-securitized resource according to the allocation scheme; and
executing an exchange of the securitized or non-securitized resource for the third resource between the first third party and a second third party.

18. The computer-implemented method of claim 17, the method further comprising:
generating a set of projected values for the securitized or non-securitized resource; and
storing the set of projected values within a database in a memory.

19. The computer-implemented method of claim 18, wherein the set of projected values are generated based on resource parameters, a set of objectives of the first third party and biographical data of the user.

20. The computer-implemented method of claim 16, wherein the securitized or non-securitized resource is a securitized resource.
